(19) United States
(12) Patent Application Publication
(10) Pub. No.: US 2024/0410856 A1
(43) Pub. Date: Dec. 12, 2024

(54) CALIBRATION REFERENCE ELEMENT FOR PH MEASURING DEVICES, CALIBRATION REFERENCE SYSTEM, HOLDER FOR A CALIBRATION REFERENCE ELEMENT, AND METHOD FOR THE CALIBRATION OF A PH MEASURING DEVICE

(71) Applicant: Mettler-Toledo GmbH, Greifensee (CH)

(72) Inventors: Silvan Lüthi, Kolbrunn (CH); Patrick Kurth, Dussnag (CH)

(21) Appl. No.: 18/688,933

(22) PCT Filed: Sep. 13, 2022
(86) PCT No.: PCT/CH2022/050025

§ 371 Date: Mar. 4, 2024

(30) Foreign Application Priority Data
Sep. 17, 2021 (CH) CH070284/2021

(51) Int. Cl. G01N 27/416; G01N 1/28

(52) U.S. Cl. CPC G01N 27/4165; G01N 1/28; G01N 2001/2893

(57) ABSTRACT

A calibration reference element for pH measuring instruments includes a reference liquid with a defined pH value and a tubular bag for holding the reference liquid. The tubular bag consists of a foil that is sealed along a maximum of three sealing edges. A calibration reference system comprised of at least two such calibration reference elements with reference liquids and different pH values. The holder used for a calibration reference element allows it to be positioned so that the reference liquid is conveniently available for calibration. Accordingly, a calibration set includes a holder and calibration reference elements or a calibration reference system.

### TECHNICAL SECTION

This description applies to the type of calibration reference element denoted in the claims. It also applies to a calibration reference system that uses the type of calibration reference element described above, a holder for this type of calibration reference element as well as the procedure for calibrating a pH measuring instrument using the items described above.

### TECHNOLOGICAL BACKGROUND

If a measuring transducer that converts a physical quantity into an electrical signal is used to record a measured value, knowing the relationship between the generated electrical signal and the actual physical quantity is an essential requirement. With many transducers or sensors, this relationship must be verified or redetermined from time-to-time as part of a calibration process so that the correct physical quantity value, based on the measured electrical signal, can be determined or displayed by the measuring instrument. This is why a defined reference value or several successively defined reference values for the physical quantity to be determined are provided and the corresponding measured electrical values are determined or a measuring instrument is set up so that the correct value for the physical quantity is displayed.

This also applies to sensors or measuring instruments used to determine the pH value. In this context, a pH sensor is successively immersing in buffer solutions of different defined pH values and a measuring instrument is for example set up to display the correct pH.

Alternatively, the electric signal emitted from the sensor in response to a pH value can be documented to be used later to determine the pH value from the electrical signal when the pH value of the measurement medium is unknown. Using a pH buffer solution as a reference liquid will ensure that the reference pH value is maintained. However, handling buffer solutions is not always unproblematic in practice. Thus, it is desirable that the sometimes highly acidic or alkaline and therefore aggressive buffer solutions are supplied in containers that make it easy to avoid spilling the buffer solutions when opening and manipulating them, at least with due care being taken. Furthermore, it is desirable that the containers holding the buffer solutions are held securely during calibration and provide unhindered access for the sensor. For economical reasons as well as for disposal of the buffer solutions, which are not unproblematic in waste water, it is still preferable to supply the reference buffer solutions so that the smallest possible quantities are required and they can still be transported and stored in a space-saving way.

### DEPICTION OF THE OBJECT OF THIS DESCRIPTION

This description refers to the items described in the introduction. According to one aspect of this description, a calibration reference element or a calibration reference system for pH measuring instruments is specified that will enable easy and safe handling when calibrating pH measuring instruments. Furthermore, a holder for this type of calibration reference element is claimed, which will ensure that the calibration reference elements are held securely in place easily. A procedure for calibrating a pH measuring instrument or a pH sensor using the previously described items is also specified here.

Other effects and benefits of the items described here, whether explicitly stated or not, arise in light of this description.

This is realized by using the calibration reference element shown in claim 1 and the items described in the other separate claims. Specific version configurations for the claimed items result from the dependent requirements.

A calibration reference element for pH measuring instruments is described accordingly, comprising a reference liquid with a defined pH value as well as a tubular bag, whereby the reference liquid is inside the tubular bag. The tubular bag is made of foil and sealed along three or fewer sealing edges and is at least partially filled with the reference liquid. As explained above, a pH buffer solution is in particular used as the reference liquid. It is possible that when the tubular bag is only partially filled with the reference liquid, the residual volume inside the tubular bag is filled with air or an inert gas. This will prevent the liquid from spilling out when the tubular bag is opened at an end held upwards. The inert gas can also increase the reference liquid's storage life. Furthermore, the tubular bag might only contain enough liquid so that, when the tubular bag is placed in a configuration intended for use during calibration, the filling level inside the open tubular bag is 30% or more and 90% or less, preferably between 50% and 80%, of the height of the inner volume of the tubular bag in said configuration. The configuration intended for use during calibration can be determined in conjunction with a holder specifically designed for use with the calibration reference element as shown below. The height of the inner volume results from the fact that a line can be marked on the outside of the tubular bag along which the tubular bag is to be opened by the user or such a line might already be provided by a suitable feature, such as a perforated line.

Furthermore, the tubular bag might comprise a label in a labeling section indicating the pH value of the reference liquid, so that label section is, if the tubular bag is placed in a configuration intended for use during calibration, positioned above the top edge of the holder and below the line along which the tubular bag is to be opened by the user. The configuration intended for use during calibration can be determined in conjunction with a holder specifically designed for use with the calibration reference element as shown below. Preferably, the label in the label section is in addition highlighted by a color that corresponds to a color code. This will ensure that the user can easily read the pH value of the reference liquid during the measuring process.

It is understood that in this context at hand, the calibration of pH measuring instruments comprises the step of documenting the relationship between the electrical output signal from the sensor and a pH-value, as described in the introduction. In this respect, calibrating pH-measuring instruments is not limited to just setting up a measuring instrument for providing correct pH values, but it also includes documenting the previously mentioned relationship between the electrical output signal from a sensor and the pH value from the measurement medium. The chosen wording is to be understood broadly, in the sense that it includes every process that is used to calibrate a device which is intended to measure pH values.

“A” or “an” should be seen as an indefinite article and not as a numeral in the context of this description unless a different meaning is explicitly stated, e.g.

“exactly one” or “precisely one”.

It can also be provided that the tubular bag comprises sealing edges at each of its two opposite end sides. Each sealing edge has a longitudinal extension that runs transversely to the longitudinal extension of the tubular bag and each one is limited by the longitudinal edge (“Längskante”) of the end side sealing edge. The tubular bag is seamless in the circumferential direction, or else it has a longitudinal sealing edge (“Längs-Verschlusskante”) that is offset from the longitudinal edges (“Längskanten”) of the end side sealing edges, or it is folded away in the circumferential direction from the adjacent longitudinal edges (“Längskanten”) of the end side sealing edges. This effectively prevents the longitudinal sealing edge (“Längs-Verschlusskante”) from causing a rigidity of shape that would otherwise predetermine a flat shape of the opened bag, as it is the case in known in packaging with two longitudinal sealing edges (“Längs-Verschlusskanten”) on opposite sides of the bag. In contrast to this, the tubular bag's material is preformed in the area of the longitudinal sealing edge (“Längs-Verschlusskante”) so that the tubular bag that is open at its top edge has only comparatively low rigidity of shape with regard to the cross-sectional shape, and if supported at the sealed bottom and otherwise suitably held, it will automatically assume an elliptical to at least essentially circular geometry that allows a sensor to gain easily access to the reference liquid inside the opened tubular bag. In exemplary embodiments, the circumference of the tubular bag and its inside is 70 mm or more or less than 80 mm. This corresponds to an equivalent circular 10 diameter in the approx. 23-27 mm range that allows good access when using a sensor with for example a 12 mm diameter. In exemplary embodiments, the length of the fillable inner volume in between the two end sides is 90 mm or more and 120 mm or less and the liquid filling capacity lies within the range of 15 ml or more and 30 ml or less. In particular, the length of the fillable inner volume lies between 110 mm and 115 mm and the filling quantity is about 20 ml. These parameters create a reference element that due to its filling level, provides adequate distance from the top edge of the tubular bag when open and arranged correctly, and this prevents the liquid from overflowing even when the sensor is immersed, whereas the sealed tubular bag is sufficiently compact for storing, transporting, and handling. In addition, a sensor's immersion depth in the reference liquid is enabled which ensures a correct measurement.

For the sake of completeness, it should be noted that the longitudinal sealing edge (“Längs-Verschlusskante”) stretches from one to the other end side sealing edges, so that the tubular bag is hermetically sealed if both end side sealing edges are present and sealed. The tubular bag is opened in particular by severing the tubular bag transversely to its longitudinal extension and adjacent to one of the end side sealing edges. It should be noted that, in conjunction with a tubular bag, its longitudinal and transversal directions as well as the end sides are implicitly defined by the tubular geometry.

In certain embodiments, the tubular bag is made from foil comprising at least two material layers. One of these material positions is on the inside of the tubular bag and the second layer is on the outside of the tubular bag. The inner layer consists of the first material, for example a first synthetic material, and the outer layer of the second material, for example a second synthetic material, whereby the materials are in particular different from each other. The first synthetic material can be selected to ensure stability against the reference liquid, whilst the second synthetic material used for the outer layer can be specifically selected to counteract environmental conditions and mechanical damage, and to further assume design functions. In other embodiments the same material can be used as the layer on the inside of the tubular bag and the layer on the outside of the tubular bag.

It is also possible to have an intermediate layer of metal foil fitted in between the layer on the inside of the tubular bag and the layer on the outside of the tubular bag. Preferably, the metal foil is an aluminum foil. Among others, the metal foil improves the stability of the reference solution during storage and transport. In particular, the layer of foil on the outside of the tubular bag and the intermediate layer of aluminum foil can be perforated, specifically laser-perforated, so that a perforated line is created. This will make it easy to open the tubular bag along a defined line, which determines the height of the inner volume. However, the layer of foil on the inside of the tubular bag should not be perforated or only be partially perforated.

A calibration reference system comprising at least two calibration reference elements of the type described above is also disclosed. At least two of the total number of all calibration reference elements used in the calibration reference system contain reference liquids with different pH values. In particular, the calibration reference elements that contain reference liquids with different pH values can be color-coded differently. This will enable the pH values of the specific reference elements to be recognised quickly during use. In specific embodiments, the calibration reference system consists of three to five calibration reference elements with different pH values.

A suitable holder for a calibration reference element of the type described above must have at least partially the shape of a triangular prism. A triangular prism is a prism with a triangular base. Said prism comprises at least one recess that extends from one of the prism's sides over the adjacent faces of the prism's lateral surface in the direction of the face of the prism's lateral surface opposite from said side. Said side defines the top edge of the holder and the face of the prism's lateral surface opposite of from said side defines the bottom side of the holder. The recess is open at the top edge. At the top edge, the recess has its maximum extension parallel to the top edge, whereby this extension decreases in direction from the top edge to the bottom side to a minimum extension. In a root section of the recess, distal to the top edge and extending along a direction from the top edge to the bottom side, this minimum extension is kept constant. The downward tapered shape in the upper section of the recess ensures that the lower section of a reference element of the type described above, which is inserted into the recess, is securely guided and supported and that it can still open widely at the top. The largest extent of the recess parallel to the top edge corresponds in particular to 75% or more and 100% or less of the diameter of a circle whose circumference is equal to that of the inner circumference of the tubular bag. The intention here is to position the holder with its bottom side pointing downwards and its top section pointing upwards on a base, and to then insert an opened reference element with its sealed bottom side into the recess so that the edges of the recess support the opened tubular bag in a direction that is parallel to the top edge. In specific embodiments the height of the holder, as measured from the bottom side to the top edge, is determined so that the top of the inserted open tubular bag protrudes from the holder. For example, this height has been determined so that the open tubular bag extends between 10% and 50% of its length above the top edge of the holder. This geometry ensures that the open upper end of the tubular bag inserted in the holder will assume an elliptical or at least an approximate circular cross-sectional shape as described above. In particular, two or more recesses can be arranged along the extent of the top edge of the holder to hold reference elements with liquids having different pH values. The number of recesses can be equal to the number of reference elements with different pH values in a set or a system of reference elements. If reference elements with different pH values are color-coded as described above, then the recesses in the holder can be color-coded accordingly as well.

A calibration set consists of a calibration reference element and a holder according to the invention. It allows particularly easy and safe calibrations of pH measuring instrument.

Preferably, the calibration set comprises of a calibration reference system and a holder, whereby the preferred holder has as many or more recesses as there are calibration reference elements with reference liquids that have different pH values in the calibration reference system. This will ensure that all of the reference elements needed for a multi-point calibration are easily and safely available to the user.

The process for calibrating a pH measuring instrument or a pH sensor using the items disclosed above includes placing the holder on a base with its top edge facing upward. At least one calibration reference element is opened adjacent to an end side of the tubular bag. The open calibration reference element is inserted into the at least one recess of the holder with the sealed end side of the tubular bag pointing downward so that the walls of the tubular bag are supported by the sides of the recess. Thereby the tubular bag forms an open top container within the recess. A pH measuring sensor can be immersed in the reference liquid through the top opening of the tubular bag. Afterwards, a measured value can be read off—as an electrical output value from the sensor or as a value that has already been converted into a pH value in a measuring instrument—and compared against the defined pH value of the reference liquid. The measured value assigned to the reference pH value can then be recorded or a measuring instrument can be set up to display a value corresponding to the reference pH value. This process can be repeated for further different reference pH values. To do so, several reference elements with different reference pH values can be inserted in the holder in which the sensor is immersed successively.

The specific embodiments mentioned above can be combined with each other. Other, non-specifically disclosed embodiments according to the teaching of this document are available to a person skilled in the art without further instructions being needed.

### BRIEF DESCRIPTION OF THE FIGURES

The issues covered here are explained in greater detail below using selected embodiments as shown in the drawings. In detail they show:

FIG. 1 an example of a reference element described herein with views from two opposite sides, whereby the tubular bag of the reference element is sealed;

FIG. 2 top view of the reference element from FIG. 1 with the tubular bag of the reference element is opened adjacent to its top border;

FIG. 3 top view of another embodiment of the reference element with opened tubular bag

FIG. 4 side view of a holder intended for use with reference elements of the type described here, with some reference elements inserted as intended, and

FIG. 5 front view of the holder in FIG. 4 with a reference element inserted as intended

These drawings are very schematic. Details that are not needed to understand the described items have been omitted. Furthermore, the drawings only show selected embodiments and must not be used to limit the devices described in the claims. Embodiments not depicted here might also be covered by the claims.

### EXEMPLARY EMBODIMENTS

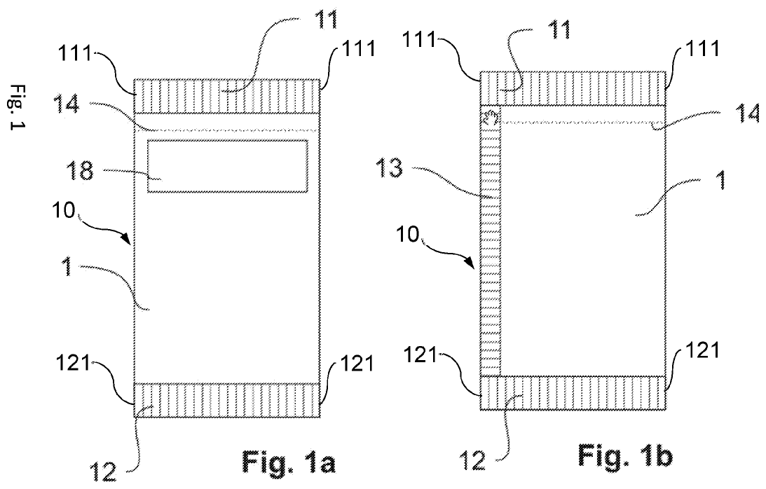

FIG. 1 shows a reference element 10 of the type previously described with a closed tubular bag 1, with FIGS. 1a and 1b showing two opposite views of reference element 10. Tubular bag 1 includes two end side sealing edges 11 and 12.

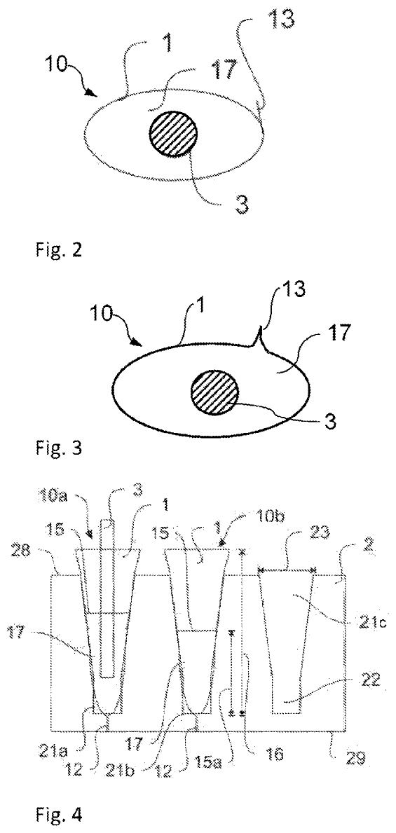

Sealing edge 11 is also called the top sealing edge, and sealing edge 12 is called the bottom sealing edge in the following: End side sealing edges 11 and 12 each have a longitudinal extension, which extends transversely to the longitudinal extension of the tubular bag. The longitudinal extension of the tubular bag extends between the end side sealing edges 11 and 12. This designation of the orientations respectively directions of the tubular bag are easy to understand in connection with FIG. 2, which shows a top view of reference element 10 with a tubular bag open along perforation line 14. End side sealing edges 11 and 12 are limited in the direction of their longitudinal extension by their longitudinal edges (“Längskanten”) 111 and 121.

Tubular bag 1 or reference element 10 comprises further a longitudinal sealing edge (“Längs-Verschlusskante”) 13, which has been folded away from the respectively adjacent longitudinal edges (“Längskanten”) of end side sealing edges 11 and 12 so that it is only visible in the FIG. 1b illustration, as is further explained in connection with FIG. 2. Tubular bag 1 shown in the example consists of a foil element which is folded down and sealed along the sealing edges, e.g. heat-sealed or glued. As tubular bag 1 only consists of a single foil element, it can be hermetically sealed using only three sealing edges. In another design that is not shown here, the tubular bag could be made from a sealed cylindrical foil element, in which only the end side sealing edges would be needed. Inside tubular bag 1 is the reference liquid, e.g. a pH buffer solution with a defined pH value, which was filled in before the tubular bag was fully sealed. It can be provided that the tubular bag is not completely filled with the reference liquid, but includes furthermore air or an inert gas. This makes it possible to open the reference element without spilling the reference liquid. The foil used for the foil element can be multilayered. The layer of foil inside the tubular bag may consist of a material that is chemically resistant to the reference liquid, whereas the layer of foil on the outside of the tubular bag may consist of a material that is resistant to environmental and mechanical effects. Another layer, e.g. aluminum foil, can also be positioned between the two previously mentioned layers. This intermediate layer will also mechanically reinforce the tubular bag. At least one of the outer layers of the multilayer tubular bag shown in the depicted embodiment is perforated along perforation line 14 adjacent to top sealing edge 11. The intention is to open the tubular bag along this line when using a reference element and this will provide access to the reference liquid contained in it. Labeling section 18 is arranged on a side of tubular bag 1, where information about the reference element, e.g. the pH of the reference liquid contained in the tubular bag or a batch number, and similar information., can be noted.

FIG. 2 shows a top view of reference element 10, with tubular bag 1 open along perforation line 18 from FIG. 1 and sensor 3 inserted in reference liquid 17 through the resulting top opening in the tubular bag. As can be clearly seen in this illustration, the longitudinal sealing edge (“Längs-Verschlusskante”) has been folded in the circumferential direction so that this sealing does not, or at least does not excessively contribute to the rigidity of shape of the tubular bag, which would otherwise produce a flat shape of the opened bag. This allows the opening, as shown, to assume an elliptical or at least approximate circular geometry, which makes it easy to insert sensor 3 through the opening and into reference liquid 17. FIG. 3 shows an embodiment where the longitudinal sealing edge (“Längs-Verschlusskante”) 13 is offset in the circumferential direction relative to the longitudinal edges (“Längskanten”) of the end side sealing edges, resulting in an analogous effect, i.e. the rigidity of shape of the tubular bag is not, or is not too significantly undesirable affected by longitudinal sealing edge (“Längs-Verschlusskante”) 13.

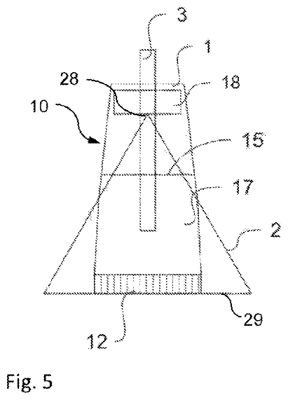

FIGS. 4 and 5 show the use of the previously described reference element 10 is used in connection with a holder 2, intended and adapted to be used with by the previously described reference element. Holder 2 has the basic shape of a triangular prism, e.g. a prism with a triangular base, as shown in FIGS. 4 and 5 in conjunction with each other. A face 29 of the prism's lateral surface defines the bottom side of the holder, whereas side 28, which is opposite of face 29, defines the top edge of the holder. As shown in FIG. 4, the example holder has three recesses, 21a, 21b, and 21c, each of which extend from the top edge 28 of the holder to the bottom side. Each of the recesses has an extent 23 in parallel to top edge 28 of the holder, which decrease in an upper section of the recess in direction to the bottom side, but which remains constant in a root section 22 of each recess. Please note that the recesses do not extend right down to the bottom side of the holder. There are reference elements 10a and 10b with their tubular bags open at the top and arranged in recesses 21a and 21b shown. The reference elements are supported at the bottom side of the holder by their respective lower sealing edge 12 and are guided in the lower section by the comparatively narrower root section 22 of the respective recess. In the upper section of the recesses, they are supported in a direction parallel to top edge 28 of the holder by the upwardly diverging sides of the recesses and they open into a funnel shape as a result of the lack of rigidity of shape. The maximum expansion of the recesses in the vicinity of the top edge 28 of the holder is chosen and coordinated with the geometry of the tubular bags in such a way that the top border of the tubular bags form an ellipse and the ellipse's axis ratio between the shorter axis and the longer axis results for example in a range between 0.5 and 1. This results in an opening at the top border of the tubular bags that makes it easy to insert a sensor through the opening and into the inside of the reference element. The volumes of reference liquid 17 are inside the tubular bags and the reference liquids in tubular bags 10a and 10b can in particular have different pH values. A tubular bag which is used as intended and inserted in holder 2 in this way has a maximum usable filling level, which is marked as 16. As can be seen in reference element 10b, the volume of reference liquid 17 was selected so that actual filling level 15a used for liquid level 15 of reference liquid 17 is lower than maximum filling level 16. In the version example shown here, the volume of filled reference liquid 17 is determined so that actual filling level 15a is approximately 60% to 75% of maximum filling level 16 when the reference element is fitted correctly in holder 2. When a sensor is immersed in reference liquid 17, liquid level 15 will rise as it is displaced by the sensor, see reference element 10a. However, the safety margin between actual filling level 15a and maximum filling level 16 is sufficiently large so that the liquid does not spill out over the top edge of the tubular bag in this case. FIG. 5 shows a front view of holder 2 with inserted reference element 10 and sensor 3 immersed in reference liquid 17 in the reference element.

Although the object of this description has been explained using selected embodiments, they are not intended to limit the claimed invention. The claims include embodiments that are not explicitly shown here as well as embodiments that differ from the examples shown here but which are still covered by the claims.

1. A calibration reference element for pH measuring instruments, comprising: a reference liquid with a defined pH value; and
a tubular bag, where the reference liquid is enclosed in the tubular bag;
wherein the tubular bag comprises a foil and is sealed along one or more sealing edges, where the number of sealing edges is not more than three, and the tubular bag is at least partially filled with the reference liquid:
wherein the calibration reference element is accessible by cutting the tubular bag transversely to its longitudinal extent and adjacent to one of the sealing edge.

2. The calibration reference element of claim 1, wherein;
the tubular bag is partially filled with the reference liquid, and a residual volume is filled with air or an inert gas.

3. The calibration reference element of claim 1, wherein:
the one or more sealing edges comprising two end side sealing edges, located on two opposite end sides of the tubular bag;
each of the two end side sealing edges has a longitudinal extension that runs transversely to the longitudinal extension of the tubular bag and is limited by a longitudinal edge of the respective end side sealing edge;
the tubular bag is seamless in circumferential direction or has a longitudinal sealing edge which is offset in the circumferential direction from the longitudinal edges of the end side sealing edges or is folded away in the circumferential direction from the adjacent longitudinal edges of the end side sealing edges.

4. The calibration reference element of claim 1, wherein:
the tubular bag of a foil that has at least two material layers, with a first of the at least two material layers on an inside of the tubular bag consisting of a first material and a second of the at least two materia layers on an outside of the tubular bag consisting of a second material.

5. The calibration reference element of claim 1, wherein:
the tubular bag consisting of a foil that has at least two material layers, with an intermediate layer consisting of a metal foil positioned between a first layer of the at least two materi vers located on an inside of the tubular bag and a second of the at least two material layers located on an outside of the tubular bag.

6. A calibration reference system, comprising:
at least two calibration reference elements for pH measuring, each comprising:
a reference liquid with a defined pH value; and
a tubular bag, where the reference liquid is enclosed in the tubular bag, wherein the tubular bag comprises a foil and at least one, but not more than three, sealing edges, and the tubular bag is at least partially filled with the reference liquid;
wherein the reference liquid of the at least two calibration reference elements have different pH values.

7. A holder for the calibration reference element of claim 1, wherein:
the holder at least partially forms the shape of a triangular prism;
the prism comprises at least one recess that extends from a respective lateral side of the prism over adjacent faces of a lateral surface of the prism in a direction of a face of a lateral surface of the prism opposite from said respective lateral side;
said respective lateral side defines a top edge of the holder and the face of the lateral surface of the prism opposite from said respective lateral side defines a bottom side of the holder;
the recess is open at the top edge, the extension of the recess parallel to the top edge decreases, starting from the top edge towards the bottom side, to a minimum extension, and this minimum extension is maintained in a root section of the recess, arranged distally from the top edge and extending along a direction from the top edge to the bottom side.

8. The holder of claim 7, wherein the largest extension of the recess parallel to the top edge is between 75% and 100%, inclusive, of a diameter of a circle whose circumference is equal to an inner circumference of the tubular bag.

9. A calibration set for pH measuring devices, comprising:
a tubular bag enclosing a reference liquid with a defined pH value. wherein the tubular bag comprises a foil and at least one, but not more than three, sealing edges. wherein the tubular bag is at least partially filled with the reference liquid; or
the calibration reference system of claim 6; and
the holder of claim 7.

10. A method for calibrating a pH measuring instrument or a pH sensor using of the calibration set of claim 9, comprising; positioning the holder with its top edge upward on a base;
opening at least one calibration reference element adjacent to an end side of the tubular bag
inserting the opened calibration reference element with the sealed end side of the tubular bag facing down into the at least one recess in the holder, such that the walls of the tubular bag are supported by the sides of the recess and the tubular bag forms an open-topped container within the recess;
immersing a sensor for measuring the pH value into the reference liquid through the upper opening of the tubular bag; and
comparing a measured value reading against the defined pH value of the reference liquid.

11. The calibration reference element of claim 1, wherein:
a material of the tubular bag is preformed in an area of the longitudinal sealing edge such that the tubular bag, which is opened at its top edge, has a comparatively low rigidity of shape with respect to a cross-sectional shape and thus when supported at the sealed bottom and otherwise suspended, automatically assumes an elliptical to at least approximately circular geometry, which enables easy access into the tubular bag with a sensor to the reference liquid inside the opened tubular bag.

12. The calibration reference element of claim 1, wherein:
a circumference of the tubular bag on its inside has a value of between 70 mm and 80 mm.

13. The calibration reference element of claim 1, wherein:
a length of a fillable inner volume of the tubular bag between the two end sides of the tubular bag is between 90 mm and 120 mm; and
the liquid filling capacity is between 15 ml and 30 ml.

14. The calibration reference element of claim 1, wherein:
a line is marked, or a perforation line is provided, on an outside of the tubular bag along which the tubular bag is to be opened by the user.

15. A method for using the at least one calibration reference element for calibrating a pH measuring device or a pH sensor, wherein:
the at least one calibration reference elements for pH measuring comprises:
a reference liquid with a defined pH value; and
a tubular bag, where the reference liquid is enclosed in the tubular bag,
wherein the tubular bag comprises a foil and at least one, but not more than three, sealing edges, and the tubular bag is at least partially filled with the reference liquid;
wherein a material of the tubular bag is preformed in an area of the longitudinal sealing edge so that the tubular bag, which is opened at its top edge, has a comparatively low rigidity of shape with regard to the cross-sectional shape;
wherein the at least one calibration reference element is supported at a sealed bottom and is otherwise suspended, so that the tubular bag opened on its upper side automatically assumes an elliptical to at least approximately circular geometry on its upper edge, thereby allowing easy access with a sensor to the reference liquid in the Inside the opened tubular bag allows.
